(19) United States
(12) Patent Application Publication
(10) Pub. No.: US 2022/0222033 A1
(43) Pub. Date: Jul. 14, 2022

(54) CUSTOMIZED VOLUME CONTROL IN SMALL SCREEN MEDIA PLAYERS

(71) Applicant: Rovi Guides, Inc., San Jose, CA (US)

(72) Inventors: Ankur Anil Aher, Kalyan (IN); Charishma Chundi, Nellore (IN)

(21) Appl. No.: 17/146,031

(22) Filed: Jan. 11, 2021

(51) Int. Cl. G06F 3/16; G06F 3/0488; G06F 3/0481

(52) U.S. Cl. CPC G06F 3/165; G06F 3/162; G06F 3/04817; G06F 3/04883

(57) ABSTRACT

This disclosure is generally directed to media systems configured to receive and play live media content. In particular, methods and systems are provided herein for effectively controlling and adjusting the volume level of an audio component of a media asset by utilizing user actions.

Accordingly, in view of the foregoing, the present disclosure provides a method for controlling the volume level of a device by initiating volume control and using user actions for accurate and user-friendly volume adjustment on mobile devices. As a result, through the implementation of embodiments disclosed herein, users will be able to enjoy a more convenient, more immersive, and richer viewing and/or listening experience.

### BACKGROUND

This disclosure is generally directed to media systems configured to receive and play live media content. In particular, methods and systems are provided herein for effectively controlling and adjusting the volume level of an audio component of a media asset by utilizing user actions.

### SUMMARY

Mobile devices, such as mobile phones, smart phones, tablet computers and media players, have become ubiquitous and are continuously growing in popularity. All around the world users carry their mobile devices to stream media content at various locations. Thus, users may require access to adjust various settings of their mobile device to watch content in different environments or at different times of day, for example.

More particularly, in the context of this disclosure, users often desire that a volume level of their device, or the audio output for a media asset playing on their device, be adjusted (e.g., increased, decreased or even muted) to suit user preferences. However, adjusting the volume of mobile devices typically requires human intervention, which can result in an inconvenient and less user-friendly experience. For example, human intervention may include manual input suitable for a volume level adjustment command using a volume button on the mobile device or by sliding a volume bar commonly displayed to users when consuming media content. For example, volume control functions commonly come with two user interface elements, (1) a volume icon, which indicates the volume control and the volume level, and (2), upon clicking or hovering above the volume icon, a volume bar, which is manipulated by the user to adjust the volume of the audio output.

Additionally, in conventional systems, volume control settings available to users are the same or very similar across media devices and media content. This is because volume control interfaces, functions and settings are typically preset by mobile manufacturers, suppliers or content providers (e.g., OTT content providers). It is clear that it is a difficult task to satisfy all users using preset volume control settings. For example, in conventional systems and methods, users are unable to reach all volume levels within the volume range, and therefore may be unable to adjust the audio output settings to match personal preferences.

Thus, there is a need for systems and methods capable of providing users with user experiences to allow users to accurately, and more conveniently, control the volume when using mobile devices (e.g., hand-held devices).

According to a first aspect, there is provided a method of adjusting a volume level on a mobile device for a media asset. The method comprises receiving the media asset comprising an audio component; outputting the audio component of the media asset at a first volume level on the mobile device; initiating volume control and, in response to initiating volume control, generating a 2D grid on a display of the mobile device for adjusting the volume level from the first volume level to a second volume level; detecting a user action for adjusting the volume level, wherein the user action comprises determining a first location on the 2D grid corresponding to the first volume level; determining the second volume level by determining that the user action has ended at a second location on the 2D grid corresponding to the second volume level; and outputting the audio component of the media asset at the second volume level.

Accordingly, in view of the foregoing, the present disclosure provides a method for controlling the volume level of a device by initiating volume control and using user actions for accurate and user-friendly volume adjustment on mobile devices. As a result, through the implementation of embodiments disclosed herein, users will be able to enjoy a more convenient, more immersive, and richer viewing and/or listening experience.

In some embodiments, the step of initiating volume control comprises any one of the user selecting a volume icon; the user selecting a volume bar; the user pressing a volume button on the mobile device; the system detecting user input at a predetermined location; and/or the system detecting a gesture at a close proximity to the display.

In some embodiments, the user action comprises a dragging action on the 2D grid from a first location to a second location. In some embodiments, the user action may be a continuous user action. The dragging action, for example, can accommodate a much greater range of volume values, e.g., 0 to 100 (minimum=0 and maximum=100).

In some embodiments, the second volume level is determined based on a distance determined from the first location to the second location on the display of the mobile device.

In some embodiments, the second volume level is determined based on a displacement of the second location with respect to the first location on the 2D grid.

In some embodiments, the second volume level is determined based on any one or more of a user preference, a user profile, type of content, and/or historical volume level adjustments. In some embodiments, a plurality of predetermined locations are preset on the 2D grid for the second location, each of the plurality of predetermined locations corresponding to a plurality of predetermined volume levels. In some embodiments, the second volume level is determined to be one of the plurality of predetermined volume levels. For example, in some embodiments, the methods can learn to adjust the volume level to a predetermined volume control level, e.g., 55, when the user's determined second location is close to, or within the region of, the half-way point between the first location and the end point on the 2D grid, e.g., the edge of the display.

In some embodiments, determining that the user action has ended comprises any one of: determining that the user action has stopped; determining that the user action has stabilized for a threshold period of time; determining that the distance between the first location and the second location has stabilized for a threshold period of time; and/or determining that a second user action for outputting the second volume level has occurred. In determining that the user action has ended, it may be determined that the user has stopped the dragging action, released contact from the display of the mobile device or provided a further user input that indicates that the user wishes to set the volume level at the adjusted volume level (the second volume level).

According to a second aspect, a system is provided for adjusting a volume level on a mobile device for a media asset. The system comprises means for receiving the media asset comprising an audio component; means for outputting the audio component of the media asset at a first volume level on the mobile device; means for initiating volume control and, in response to initiating volume control; means for generating a 2D grid on a display of the mobile device for adjusting the volume level from the first volume level to a second volume level; means for detecting a user action for adjusting the volume level, wherein the user action comprises determining a first location on the 2D grid corresponding to the first volume level; means for determining the second volume level by determining that the user action has ended at a second location on the 2D grid corresponding to the second volume level; and means for outputting the audio component of the media asset at the second volume level.

According to a third aspect, a non-transitory computer-readable medium is provided comprising non-transitory computer-readable instructions encoded thereon for adjusting a volume level on a mobile device for a media asset. The instructions comprises instructions for receiving the media asset comprising an audio component; instructions for outputting the audio component of the media asset at a first volume level on the mobile device; instructions for initiating volume control and, in response to initiating volume control, instructions for generating a 2D grid on a display of the mobile device for adjusting the volume level from the first volume level to a second volume level; instructions for detecting a user action for adjusting the volume level, wherein the user action comprises determining a first location on the 2D grid corresponding to the first volume level; instructions for determining the second volume level by determining that the user action has ended at a second location on the 2D grid corresponding to the second volume level; and instructions for outputting the audio component of the media asset at the second volume level.

It should be noted that the systems, methods, apparatuses, and/or aspects described above may be applied to, or used in accordance with, other systems, methods, apparatuses, and/or aspects described in this disclosure.

### BRIEF DESCRIPTION OF THE DRAWINGS

The above and other objects and advantages of the disclosure will be apparent upon consideration of the following detailed description, taken in conjunction with the accompanying drawings, in which reference characters refer to like parts throughout, and in which:

FIG. 1 shows an illustrative depiction of an example user device, in accordance with some embodiments of the present disclosure;

FIG. 2 shows a block diagram of an illustrative user equipment system, in accordance with some embodiments of the present disclosure;

FIG. 3 shows an example user interface typically encountered by users when consuming media asset content, in accordance with conventional systems and methods;

FIG. 4 is a flowchart of illustrative steps involved in controlling and adjusting the volume level of audio output, in accordance with some embodiments of the present disclosure;

FIG. 5 is a flowchart of illustrative steps involved in controlling and adjusting the volume level based on predetermined locations for volume level adjustment, in accordance with some embodiments of the present disclosure;

FIG. 6 shows an example illustration of a user interface, in accordance with some embodiments of the present disclosure;

FIG. 7 shows an example illustration of using proximity touch to initiate volume control and/or adjust volume level, in accordance with some embodiments of the present disclosure.

The figures herein depict various embodiments of the disclosed invention for purposes of illustration only. It will be appreciated that additional or alternative structures, systems and methods may be implemented within the principles set out by the present disclosure.

### DETAILED DESCRIPTION

This disclosure is generally directed to media systems configured to receive and play live media content. In particular, methods and systems are provided herein for effectively controlling and adjusting the volume level of an audio component of a media asset by utilizing user actions.

Mobile devices, such as mobile phones, smart phones, tablet computers, media players, have become ubiquitous and are continuously growing in popularity. All around the world users carry their mobile devices while on the go to stream media content at various locations, and so users may require the full range of settings of the mobile device to be available to watch content in different environments or at different times of day, for example, to be adjusted based on user preferences.

More particularly, in the context of this disclosure, users often desire that a volume level of their device, or the audio output for a media asset playing on their device, be adjusted (e.g., increased, decreased or even muted) to suit user preferences. However, adjusting the volume of mobile devices typically requires human intervention, which can be inconvenient. For example, human intervention may include manual input by using a volume button on the mobile device or by sliding a volume bar commonly displayed to users when consuming media content. In conventional systems, the volume control function commonly comes with two user interface elements, (1) a volume icon, which indicates the volume control and the volume level, and (2), a volume bar, which is manipulated by the user to adjust the volume of the audio output.

In example embodiments, methods and systems are provided to allow users to more accurately, and more conveniently, control volume settings when using mobile devices (e.g., hand-held devices).

Accordingly, in view of the foregoing, the present disclosure provides systems and related methods for controlling the volume level of devices by initiating volume control and using user actions for accurate and user-friendly volume adjustment on mobile devices. As a result, through the implementation of embodiments disclosed herein, users will be able to enjoy a more convenient, more immersive, and richer viewing and/or listening experience.

As referred to herein, a “media guidance application” or a “guidance application” is an application that provides media guidance data to a user through an interface. For example, a media guidance application may allow users to efficiently navigate content selections and easily identify content that they may desire. The media guidance application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and nonvolatile computer memory or storage devices such as a hard disk, floppy disk, USB drive, DVD, CD, media cards, register memory, processor caches, Random Access Memory (RAM), etc.

As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As referred to herein, the terms “media asset” and “media content” should be understood to mean an electronically consumable user asset, such as a live televise program, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate and locate content.

As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, or wireless device, and/or combination of the same.

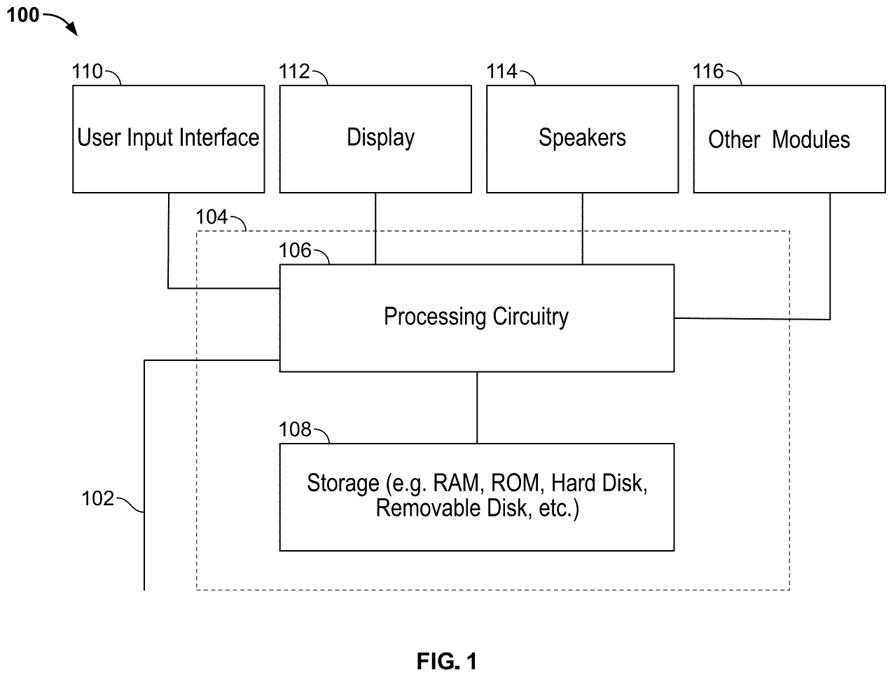

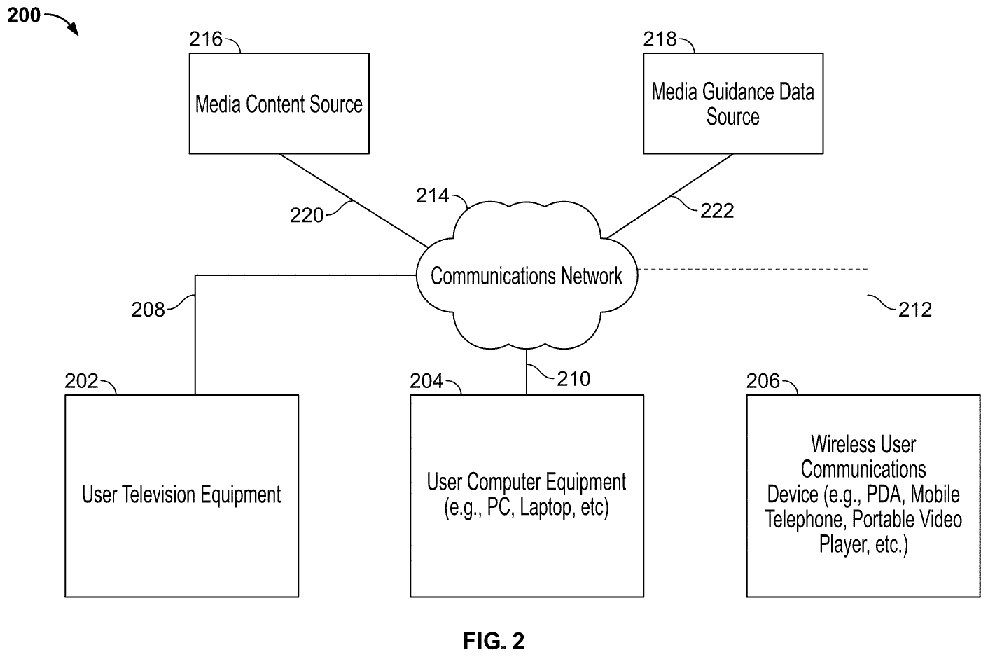

Users may access content and the media guidance application (and its display screens described above and below) from one or more of their user equipment devices. FIG. 1 shows a generalized embodiment of illustrative user equipment device 100. More specific implementations of user equipment devices are discussed below in connection with FIG. 2. User equipment device 100 may receive content and data via input/output (hereinafter “I/O”) path 102. I/O path 102 may provide content (e.g., broadcast programming, on-demand programming, Internet content, content available over a local area network (LAN) or wide area network (WAN), and/or other content) and data to control circuitry 104, which includes processing circuitry 106 and storage 108. Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

Control circuitry 104 may be based on any suitable processing circuitry such as processing circuitry 106. As referred to herein, processing circuitry should be understood to mean circuitry based on one or more microprocessors, microcontrollers, digital signal processors, programmable logic devices, field programmable gate arrays (FPGAs), application-specific integrated circuits (ASICs), etc., and may include a multi-core processor (e.g., dual-core, quad-core, hexacore, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 104 executes instructions for a media guidance application stored in memory (i.e., storage 108). Specifically, control circuitry 104 may be instructed by the media guidance application to perform the functions discussed above and below. For example, the media guidance application may provide instructions to control circuitry 104 to generate the media guidance displays. In some implementations, any action performed by control circuitry 104 may be based on instructions received from the media guidance application.

In client-server based embodiments, control circuitry 104 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 2). In addition, communications circuitry may include circuitry that enables peer-to-peer communication of user equipment devices, or communication of user equipment devices in locations remote from each other.

Memory may be an electronic storage device provided as storage 108 that is part of control circuitry 104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 108 may be used to store various types of content described herein as well as media guidance data described above. Nonvolatile memory may also be used (e.g., to launch a boot-up routine and other instructions). Cloud-based storage, described in relation to FIG. 2, may be used to supplement storage 108 or instead of storage 108.

Control circuitry 104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 104 may also include scaler circuitry for upconverting and downconverting content into the preferred output format of the user equipment 100. Circuitry 104 may also include digital-to-analog converter circuitry and analog-to-digital converter circuitry for converting between digital and analog signals.

The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 108 is provided as a separate device from user equipment 100, the tuning and encoding circuitry (including multiple tuners) may be associated with storage 108.

A user may send instructions to control circuitry 104 using user input interface 110. User input interface 110 may be any suitable user interface, such as a remote control, mouse, trackball, keypad, keyboard, touchscreen, touchpad, stylus input, joystick, voice recognition interface, or other user input interfaces.

Display 112 may be provided as a stand-alone device or integrated with other elements of user equipment device 100. For example, display 112 may be a touchscreen or touch-sensitive display. In such circumstances, user input interface 112 may be integrated with or combined with display 112. Display 112 may be one or more of a monitor, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images.

In some embodiments, display 112 may be HDTV-capable. In some embodiments, display 112 may be a 3D display, and the interactive media guidance application and any suitable content may be displayed in 3D. A video card or graphics card may generate the output to the display 112. The video card may offer various functions such as accelerated rendering of 3D scenes and 2D graphics, MPEG5 2/MPEG-4 decoding, TV output, or the ability to connect multiple monitors. The video card may be any processing circuitry described above in relation to control circuitry 104. The video card may be integrated with the control circuitry 104. Speakers 114 may be provided as integrated with other elements of user equipment device 100 or may be stand-alone units. The audio component of videos and other content displayed on display 112 may be played through speakers 114. In some embodiments, the audio may be distributed to a receiver (not shown), which processes and outputs the audio via speakers 114.

User equipment device 100 may also incorporate or be accessible to one or more other modules 116. For example, a detection module 116 including various components (e.g., a video detection component, an audio detection component, etc.) or one or more sensory modules (e.g., a contact touch sensory module, a proximity touch sensory module, etc.).

The media guidance application may be implemented using any suitable architecture. For example, it may be a stand-alone application wholly-implemented on user equipment device 100. In such an approach, instructions of the application are stored locally (e.g., in storage 108), and data for use by the application is downloaded on a periodic basis (e.g., from an out-of-band feed, from an Internet resource, or using another suitable approach). Control circuitry 104 may retrieve instructions of the application from storage 108 and process the instructions to generate any of the displays discussed herein. Based on the processed instructions, control circuitry 104 may determine what action to perform when input is received from input interface 110. For example, movement of a cursor on a display up/down may be indicated by the processed instructions when input interface 110 indicates that an up/down button was selected.

In some embodiments, the media guidance application is a client-server based application. Data for use by a thick or thin client implemented on user equipment device 100 is retrieved on-demand by issuing requests to a server remote to the user equipment device 100. In one example of a client-server based guidance application, control circuitry 104 runs a web browser that interprets web pages provided by a remote server. For example, the remote server may store the instructions for the application in a storage device. The remote server may process the stored instructions using circuitry (e.g., control circuitry 104) and generate the displays discussed above and below.

The client device may receive the displays generated by the remote server and may display the content of the displays locally on equipment device 100. This way, the processing of the instructions is performed remotely by the server while the resulting displays are provided locally on equipment device 100. Equipment device 100 may receive inputs from the user via input interface 110 and transmit those inputs to the remote server for processing and generating the corresponding displays. For example, equipment device 100 may transmit a communication to the remote server indicating that an up/down button was selected via input interface 110. The remote server may process instructions in accordance with that input and generate a display of the application corresponding to the input (e.g., a display that moves using a cursor up/down). The generated display is then transmitted to equipment device 100 for presentation to the user.

In some embodiments, the media guidance application is downloaded and interpreted or otherwise run by an interpreter or virtual machine (run by control circuitry 104). In some embodiments, the guidance application may be encoded in the ETV Binary Interchange Format (EBIF), received by control circuitry 104 as part of a suitable feed, and interpreted by a user agent running on control circuitry 104. For example, the guidance application may be an EBIF application. In some embodiments, the guidance application may be defined by a series of JAVA-based files that are received and run by a local virtual machine or other suitable middleware executed by control circuitry 104. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 100 of FIG. 1 can be implemented in system 200 of FIG. 2 as user television equipment 202, user computer equipment 204, wireless user communications device 206, or any other type of user equipment suitable for accessing content. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 1 may not be classified solely as user television equipment 202, user computer equipment 204, or a wireless user communications device 206. For example, user television equipment 202 may, like some user computer equipment 204, be Internet-enabled allowing for access to Internet content, while user computer equipment 204 may, like some television equipment 202, include a tuner allowing for access to television programming. The media guidance application may have the same layout on various different types of user equipment or may be tailored to the display capabilities of the user equipment. For example, on user computer equipment 204, the guidance application may be provided as a web site accessed by a web browser. In another example, the guidance application may be scaled down for wireless user communications devices 206.

In system 200, there may be more than one of each type of user equipment device but only one of each is shown in FIG. 2 to avoid overcomplicating the drawing. In addition, each user may utilize more than one type of user equipment device and also more than one of each type of user equipment device. In some embodiments, a user equipment device (e.g., user television equipment 202, user computer equipment 204, wireless user communications device 206) may be referred to as a “second screen device” or “secondary device”.

The user may also set various settings to maintain consistent media guidance application settings, e.g., volume settings, across in-home devices and remote devices. Settings include programming preferences that the guidance application utilizes to make programming recommendations, display preferences, and other desirable guidance settings. For example, if a user sets a preferred volume level as a favorite volume level on, for example, a web site mobile phone, the same settings would appear on the user's in-home devices (e.g., user television equipment and user computer equipment), if desired. Therefore, changes made on one user equipment device can change the guidance experience on another user equipment device, regardless of whether they are the same or a different type of user equipment device.

The user equipment devices may be coupled to communications network 214. Namely, user television equipment 202, user computer equipment 204, and wireless user communications device 206 are coupled to communications network 214 via communications paths 208, 210, and 212, respectively. Communications network 214 may be one or more networks including the Internet, a mobile phone network, mobile voice or data network (e.g., a 4G or LTE network), cable network, public switched telephone network, or other types of communications network or combinations of communications networks. Paths 208, 210, and 212 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths.

Path 212 is drawn with dotted lines to indicate that in the exemplary embodiment shown in FIG. 2 it is a wireless path and paths 208 and 210 are drawn as solid lines to indicate they are wired paths (although these paths may be wireless paths, if desired). Communications with the user equipment devices may be provided by one or more of these communications paths, but are shown as a single path in FIG. 2 to avoid overcomplicating the drawing.

Although communications paths are not drawn between user equipment devices, these devices may communicate directly with each other via communication paths, such as those described above in connection with paths 208, 210, and 212, as well as other short-range point-to-point communication paths, such as USB cables, IEEE 1394 cables, wireless paths (e.g., Bluetooth, infrared, IEEE 702-11x, etc.), or other short-range communication via wired or wireless paths. BLUETOOTH is a certification mark owned by Bluetooth SIG, INC. The user equipment devices may also communicate with each other directly through an indirect path via communications network 214.

System 200 includes content source 216 and media guidance data source 218 coupled to communications network 214 via communication paths 220 and 222, respectively. Paths 220 and 222 may include any of the communication paths described above in connection with paths 208, 210, and 212. Communications with the content source 216 and media guidance data source 218 may be exchanged over one or more communications paths, but are shown as a single path in FIG. 2 to avoid overcomplicating the drawing. In addition, there may be more than one of each of content source 216 and media guidance data source 218, but only one of each is shown in FIG. 2 to avoid overcomplicating the drawing. (The different types of each of these sources are discussed below.) If desired, content source 216 and media guidance data source 218 may be integrated as one source device. Although communications between sources 216 and 218 with user equipment devices 202, 204, and 206 are shown as through communications network 214, in some embodiments, sources 216 and 218 may communicate directly with user equipment devices 202, 204, and 206 via communication paths (not shown) such as those described above in connection with paths 208, 210, and 212.

Content source 216 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 216 may be the originator of content (e.g., a television broadcaster, a Webcast provider, etc.) or may not be the originator of content (e.g., an on-demand content provider, an Internet provider of content of broadcast programs for downloading, etc.). Content source 216 may include cable sources, satellite providers, on-demand providers, Internet providers, over-the-top content providers, or other providers of content. Content source 216 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 218 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Media guidance applications may be, for example, stand-alone applications implemented on user equipment devices. For example, the media guidance application may be implemented as software or a set of executable instructions which may be stored in storage 108, and executed by control circuitry 104 of a user equipment device 100. In some embodiments, media guidance applications may be client-server applications where only a client application resides on the user equipment device, and server application resides on a remote server. For example, media guidance applications may be implemented partially as a client application on control circuitry 104 of user equipment device 100 and partially on a remote server as a server application (e.g., media guidance data source 218) running on control circuitry of the remote server. When executed by control circuitry of the remote server (such as media guidance data source 218), the media guidance application may instruct the control circuitry to generate the guidance application displays and transmit the generated displays to the user equipment devices. The server application may instruct the control circuitry of the media guidance data source 218 to transmit data for storage on the user equipment. The client application may instruct control circuitry of the receiving user equipment to generate the guidance application displays.

Content and/or media guidance data delivered to user equipment devices 202, 204, and 206 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT. In addition to content and/or media guidance data, providers of OTT content can distribute media guidance applications (e.g., web-based applications or cloud-based applications), or the content can be displayed by media guidance applications stored on the user equipment device.

Media guidance system 200 is intended to illustrate various approaches, or network configurations, by which user equipment devices and sources of content and guidance data may communicate with each other for the purpose of accessing content and providing media guidance. The embodiments described herein may be applied in any approach that does not deviate from the teachings of this disclosure, for example in a system employing an approach for delivering content and providing media guidance.

In an example approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 214. These cloud resources may include one or more content sources 216 and one or more media guidance data sources 218. In addition or in the alternative, the remote computing sites may include other user equipment devices, such as user television equipment 202, user computer equipment 204, and wireless user communications device 206. For example, the other user equipment devices may provide access to a stored copy of a video or a streamed video.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 1.

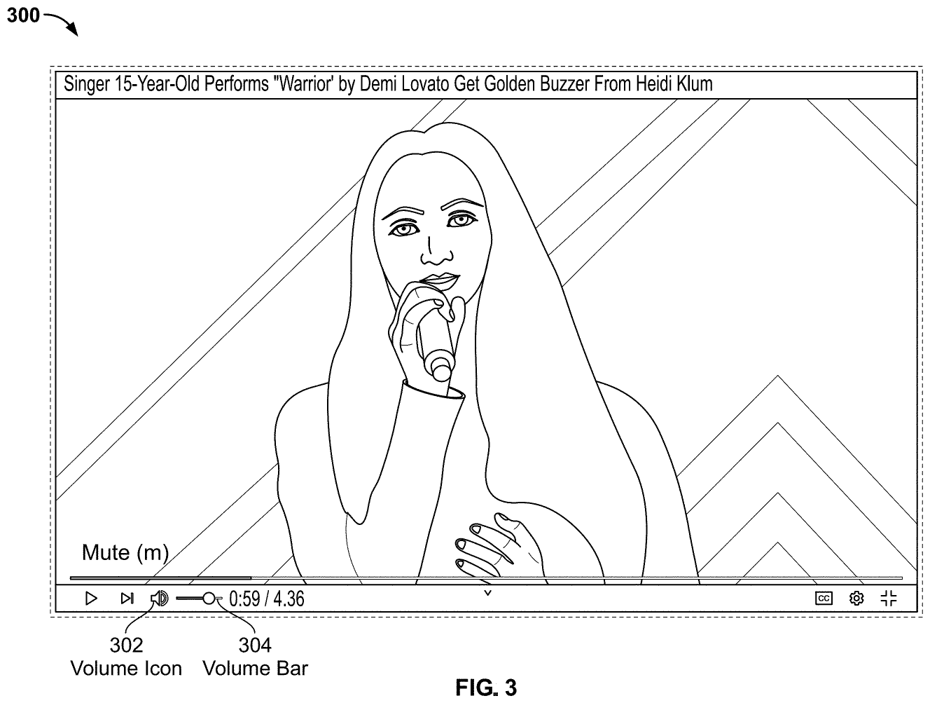

FIG. 3 shows an example user interface 300 users are typically faced with when consuming media assets. With reference to FIG. 3, problems that are commonly encountered by users when interacting with volume control functions of conventional user interfaces, such as user interface 300, will now be described.

Small screen devices, e.g., mobile devices that play video or both video and audio, either offline or online, generally come with volume control features, e.g., a volume bar 304. Such volume control features can be controlled or adjusted to increase, decrease or mute the volume level of the audio that is output by media devices. In some cases, the volume bar 304 may not always be visible to the user. For example, the volume bar 304 indicating the volume level may be shown only when the volume icon 302 is selected by the user. Only then can the user adjust the volume via the volume bar 304, making this a multi-input task for the user in such cases.

In conventional user interfaces, such as that depicted in FIG. 3, the exact volume level (or value) is not typically displayed to the user. Instead, the volume level is approximated and is usually displayed using a number of curved lines, e.g., on the right side of the volume icon 302. For example, in the display shown in FIG. 3, if the volume level is above 50% within the volume range, two curved lines may be generated for display adjacent to the volume icon 302. Similarly, one curved line can be shown as an indication that the volume level is less than 50% of the maximum volume level. Although this gives the user an indication of the approximate volume, without knowing the exact volume, the user is unable to accurately adjust the volume level of the device or audio output.

When adjusting the volume, user input is typically required. For example, the user may be required to drag a cursor or finger along the volume bar 304. The volume bar 304 is typically a horizontal or vertical bar that the user has to manually adjust. However, this is not so user-friendly, and the user has be careful when adjusting the volume level. Otherwise, the user will be forced to repeatedly adjust the volume level by dragging the volume bar 304 back and forth in an attempt to reach the user's desired volume level. On top of that, the volume bar 304 may be inconveniently placed for the user.

On mobile phones, for example, volume buttons are available, which can also be used to increase and decrease volume. These volume buttons are typically placed on one side of the mobile device, and therefore, depending on how the device is manufactured, the volume buttons may be inconveniently placed for some users. For example, volume buttons placed on the right side on the device may be inconvenient for left-handed users. Additionally, volume buttons usually increase and decrease the volume level in larger steps, e.g., 10 steps of 10% for a volume range of 0% to 100% (or, e.g., 0-10, minimum=0, maximum=10). Thus, users may be unable to access all levels of volume that match user preferences when using volume buttons to control the volume and, therefore, this can lead to an unsatisfactory user experience.

Conventional systems can result in poor user experience and may also lead to ergonomic problems for the user, such as wrist pains. Thus, there is a clear inconvenience for users when interacting with conventional systems and methods of volume control. It will be appreciated that the following description seeks to overcome the problems of conventional systems and methods.

In example embodiments, systems and methods are disclosed for providing users with an ability to control the volume level on a device more accurately and more conveniently, especially when interacting with small screen devices. More particularly, in view of the foregoing, the present disclosure provides systems and related methods for controlling the volume level of devices by initiating volume control, and, in response to initiating volume control, generating a 2D grid on a display of the mobile device for adjusting the volume level from the first volume level to a second volume level and using user actions suitable for more accurate volume adjustments and an enhanced user experience when using mobile devices. For example, the present disclosure provides a method that can allow the user to drag, using contact touch or proximity touch, along the 2D grid on the display of the mobile device in any direction to adjust and reach the user's preferred or desired volume level.

As a result, through the implementation of embodiments disclosed herein, users will be able to enjoy a more convenient, more immersive, and richer viewing and listening experience when consuming media assets using small screen devices.

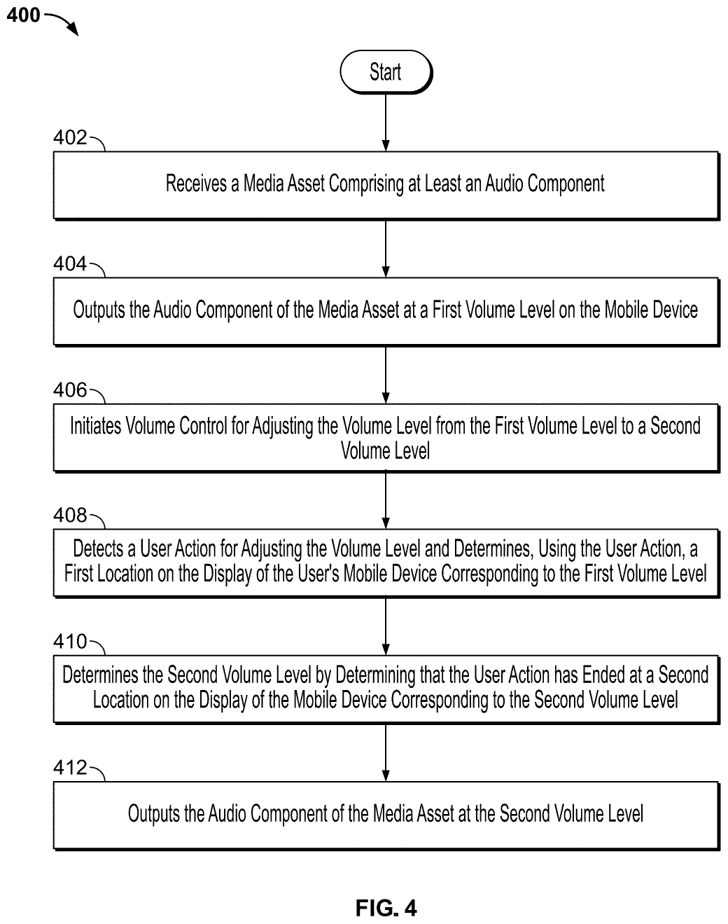

FIG. 4 is a flowchart of the steps involved in adjusting the volume level of audio output from a mobile device, in accordance with some embodiments of the present disclosure. It should be noted that process 400 or any step thereof could be performed on, or provided by, any of the devices shown in FIGS. 1-2. For example, process 400 may be executed by control circuitry 104 (FIG. 1) as implemented on user equipment 202, 204, and/or 206 (FIG. 2). In addition, one or more steps of process 400 may be incorporated into or combined with one or more steps of any other process or embodiment disclosed herein.

At step 402, the media guidance application receives, and playing, a media asset comprising at least an audio component. It shall be appreciated that various embodiments herein can be implemented for audio only media content and/or audio and video media content.

At step 404, the user equipment device outputs the audio component of the media asset at a first volume level, e.g., on the mobile device. For example, the first volume level may be the initial volume level of the media asset or, if the volume has already been adjusted by the user or has been adjusted automatically, the first volume level may be the current volume level output from the mobile device.

At step 406, the user initiates volume control and, in response to initiating volume control, the media guidance application generates a 2D grid on a display of the mobile device for adjusting the volume level from the first volume level to a second volume level.

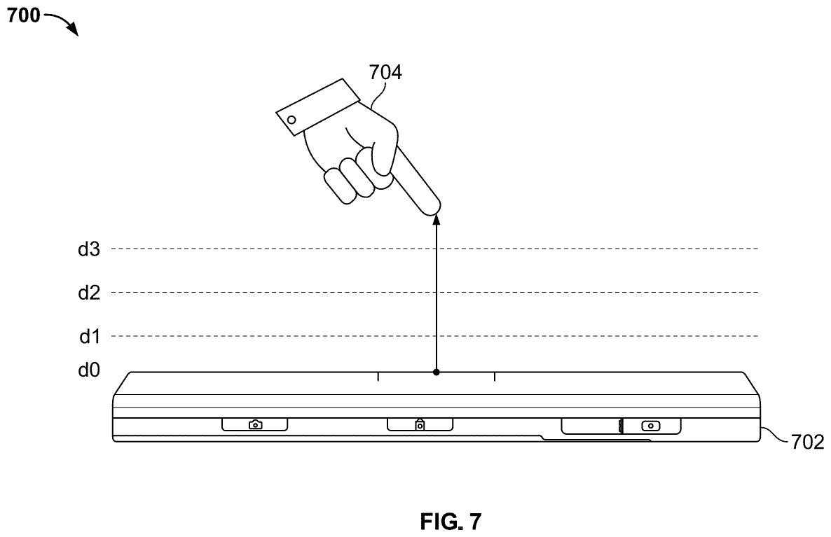

In some embodiments, volume control may be initiated by a user selecting the volume icon or volume bar displayed on the user's device, e.g., by contact touch on the display screen of the mobile device. In some embodiments, if volume control is initiated by user input using contact touch, the system may determine the point of contact on the display of the media device as the starting point for adjusting the volume level, i.e., the point from which the volume level is determined to increase or decrease. In some embodiments, volume control may be initiated using a proximity touch, e.g., detecting a gesture at a close proximity to the display screen of the mobile device (as will be further described with reference to FIG. 7), or any other user input, e.g., using volume buttons on the mobile device.

In example embodiments, following the initiation of volume control, a 2D grid (visible or invisible) may be generated for volume adjustment from the first volume level to a second volume level. For example, the second volume level can be determined based on a distance calculated between the first location and the second location on the 2D grid on the display of the mobile device. In some embodiments, determining the distance between the first location and the second location comprises determining a displacement of the second location with respect to the first location on the 2D grid, e.g., a 2D vector from the first location to the second location.

At step 408, the media guidance application detects a user action suitable for adjusting the volume level from the first volume level to the second volume level. The user action, either by contact touch or proximity touch on the display of the mobile device, can be used to adjust the volume level and starts with a step of determining a first location on the 2D grid. In example embodiments, the first location on the 2D grid corresponds to the first volume level.

At step 410, the media guidance application determines the second volume level by determining that the user action has ended at a second location on the 2D grid on the display of the mobile device. In example embodiments, the second location on the 2D grid corresponds to the second volume level (or the user-adjusted volume level). In some embodiments, the second volume level can be further determined or adjusted based on a user preference, a user profile, type of content, and/or historical volume level adjustments, for example.

In some embodiments, the user action may be a continuous user action. For example, the user action may be provided by the user in the form of a dragging action on the 2D grid on the display screen of the mobile device from the first location to the second location. The dragging motion, for example, can be beneficial as it allows the user to access the full range of volume levels, e.g., 0 to 100 (minimum=0 and maximum=100).

In example embodiments, based on the user action, it can be determined whether the user wishes to increase, decrease or mute the output volume. In some embodiments, for example, the initial direction of the user's dragging motion may determine whether the volume is increased or decreased. In this way, the user can drag in any direction from a first location, and the distance between the first location and the second location can be calculated to apply a volume adjustment to the volume bar and/or volume setting.

In example embodiments, substantially vertical or substantially horizontal user actions may indicate that the user wishes to increase or decrease the volume level. For example, given the 2D grid, a y-axis and an x-axis may be generated with the origin set as the location on the 2D grid where volume control has been initiated. In another example, the y-axis and the x-axis for the 2D grid may be generated with the origin set as the volume icon, for example. In yet another example, the y-axis and the x-axis for the 2D grid may be generated with the origin set as the first location determined by the user, for example.

The volume may be increased or decreased as the distance between the first location and the second location increases or decreases, respectively. The volume may return to the initial volume (the first volume level) as the distance between the first location and the second location decreases to 0 or substantially 0. In one example, the volume may increase as the user's dragging action continuously moves away from the volume icon, and the volume may return to the initial volume as the user's dragging motion returns to the volume icon (i.e., such that the first and second location are the same, essentially resulting in no change in volume level).

In some embodiments, the user action can be determined to have ended if it is determined that the user has stopped the dragging action, released contact from the display of the mobile device or indicated that he/she wishes to fix the volume level at the adjusted volume level (the second volume level). In other embodiments, determining that the user action has ended may be based on, but not limited to, the user action has stopped, the user action has stabilized for a threshold period of time, the distance between the first location and the second location has stabilized for a threshold period of time, and/or a second user action for outputting the second volume level has occurred.

At step 412, the user equipment device outputs the audio component of the media asset at the second volume level, i.e., the adjusted volume level. It will be appreciated that the steps outlined in FIG. 4 may be repeated for further volume adjustments.

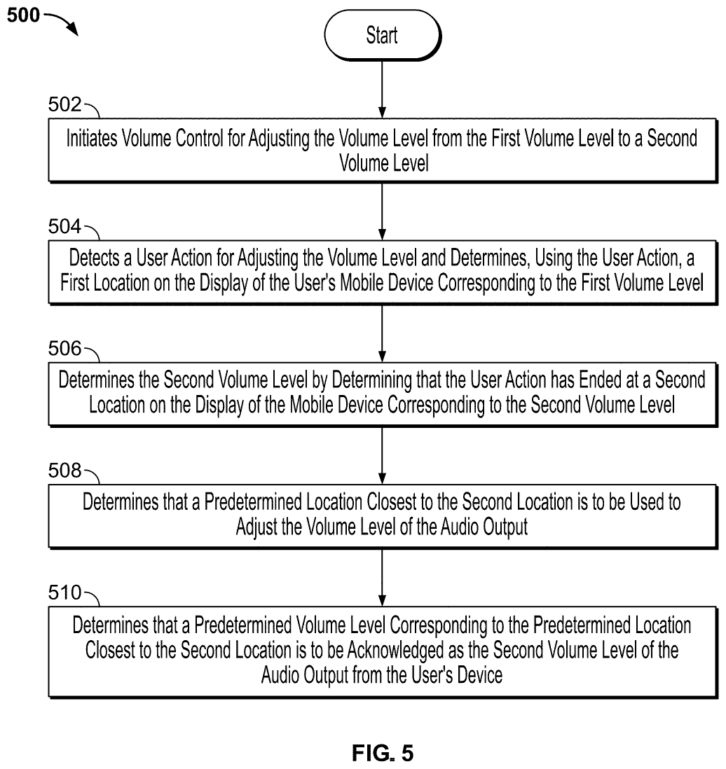

FIG. 5 is a flowchart of illustrative steps involved in controlling and adjusting the volume level based on predetermined locations for volume level adjustment. It should be noted that process 500 or any step thereof could be performed on, or provided by, any of the devices shown in FIGS. 1-2. For example, process 500 may be executed by control circuitry 104 (FIG. 1) as implemented on user equipment 202, 204, and/or 206 (FIG. 2). In addition, one or more steps of process 500 may be incorporated into or combined with one or more steps of any other process or embodiment disclosed herein.

At step 502, the user initiates volume control and, in response to initiating volume control, a 2D grid is generated on a display of the mobile device for adjusting the volume level from the first volume level to a second volume level.

In some embodiments, volume control may be initiated by a user selecting the volume icon or volume bar displayed on the user's device, e.g., by contact touch on the display screen of the mobile device. In some embodiments, if volume control is initiated by user input using contact touch, the system may determine the point of contact on the display of the media device as the starting point for adjusting the volume level, i.e., the point from which the volume level is determined to increase or decrease. In some embodiments, volume control may be initiated using a proximity touch, e.g., detecting a gesture at a close proximity to the display screen of the mobile device (as will be further described with reference to FIG. 7), or any other user input, e.g., using volume buttons on the mobile device.

In example embodiments, following the initiation of volume control, a 2D grid (visible or invisible) may be generated for volume adjustment from the first volume level to a second volume level. For example, the second volume level can be determined based on a distance calculated between the first location and the second location on the 2D grid on the display of the mobile device. In some embodiments, determining the distance between the first location and the second location comprises determining a displacement of the second location with respect to the first location on the 2D grid, e.g., a 2D vector from the first location to the second location.

At step 504, the media guidance application detects a user action suitable for adjusting the volume level from the first volume level to the second volume level. The user action, either by contact touch or proximity touch on the display of the mobile device, can be used to adjust the volume level and starts with a step of determining a first location on the 2D grid. In example embodiments, the first location on the 2D grid corresponds to the first volume level.

At step 506, the media guidance application determines the second volume level by determining that the user action has ended at a second location on the 2D grid on the display of the mobile device corresponding to the second volume level. In some embodiments, the second volume level can be further determined or adjusted based on a user preference, a user profile, type of content, and/or historical volume level adjustments, for example.

At step 508, the media guidance application determines one of a plurality of predetermined locations, nearest to the user-adjusted second location. The predetermined location can be used to adjust the volume level of the audio output, once the user action is determined to have ended. In some embodiments, the plurality of predetermined locations can be preset on the 2D grid as adjustable second locations for adjusting the volume level. In some embodiments, each of the plurality of predetermined locations may correspond to a plurality of predetermined volume levels for the audio output, either set manually, automatically, by the content provider or based on user preferences.

At step 510, the media guidance application determines the volume level corresponding to the predetermined location nearest to the second location as the adjusted or new volume level (second volume level) for output. For example, the plurality of locations on the 2D grid on the display of the mobile device suitable for the user, and tailored towards the user's preferences, can be provided as pre-set volume control settings. Thus, systems and methods provided herein can provide a more personalized volume control function and/or interface for individual users, devices or profiles.

In some embodiments, systems and methods can learn to adjust the volume level to a predetermined volume control level, e.g., 55, when the user's determined second location is close to, or within the region of, the halfway point from the first location and the end point, e.g., the edge of the display or 2D grid. In some embodiments, the systems and methods may learn user preferences based on previous volume adjustment data stored for the user or from a user profile. User information and historical volume adjustments made by the user can be used to learn and determine the user's desired volume control settings at certain times of day, at certain locations or for certain types or genre of media assets, for example.

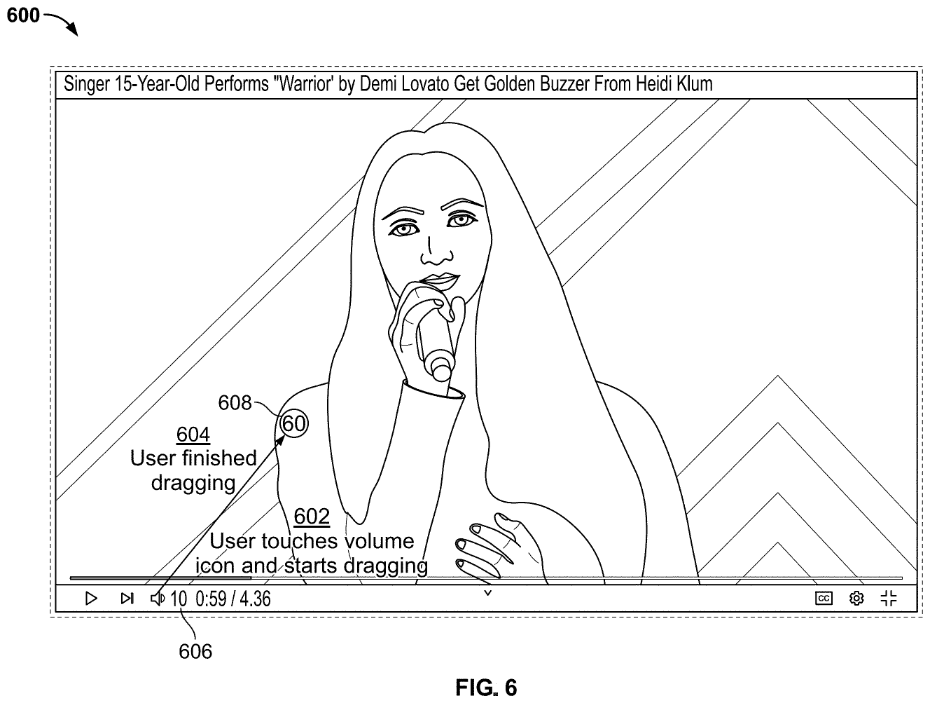

FIG. 6 shows an example illustration of a user interface, in accordance with some embodiments of the present disclosure.

In some embodiments, the volume bar may be removed and only the volume icon 602 may be generated for display on the display screen of the user's mobile device. By removing the volume bar, space on the display screen can be saved, providing a wider viewing experience or a closer-to-full-screen viewing experience for the user. This is particularly important for users of small screen devices such as mobile phones. Alternatively, the additional space provided by removing the volume bar can be used to provide other user interface functions or elements, e.g., to display the exact volume level 606 next to the volume icon 602.

In some embodiments, instead of displaying a number of curved lines next to the volume icon 602 that indicate an approximate volume level, e.g., approximately 50%, less than 50% volume or greater than 50% volume, the exact value of the volume level 606 may be shown to the user, e.g., 10% or 10 (out of a range of 0 to 100). Displaying the exact level of volume 606 can help the user to adjust the volume more accurately to reach their desired volume level and is therefore a useful feature for precise volume control. Additionally, as the user can see the exact volume level 606, there is no need for the user to repeatedly drag the volume bar back and forth to reach the user's desired volume position or volume level. The frustration of having to constantly adjust the volume level is one that is commonly experienced by users, especially when interacting with small screen devices.

In some embodiments, the new volume level 608, described herein as the second volume level or the adjusted volume level, can be displayed while the user implements the user action, either by proximity touch or contact touch on the display. For example, as shown as 608 in FIG. 6, the exact volume, e.g., 60, can be displayed along the arrow of the dragging motion, e.g., next to the location on the 2D grid where the user finished dragging, indicated as 604 in FIG. 3.

In example embodiments, it may be preferable that the volume bar, volume icon and/or volume level is/are positioned on the display of the mobile device at a section or region of the display screen that does not obstruct, or minimally obstructs, the user's view of the media asset being consumed. In some embodiments, the positioning of the volume bar, volume icon and/or volume level may be determined to be a location or locations on the display of the mobile device that obscure the least important area of the display screen, e.g., a corner section of the display screen.

In some embodiments, the volume adjustment user action, e.g., the dragging action, can be implemented vertically, horizontally, substantially vertically and/or substantially horizontally in order to bring uniformity to volume control across user devices. Alternatively, the user may determine whether the volume adjustment mechanism is to be placed or implemented vertically or horizontally based on his/her preference.

In some embodiments, a user equipment device (e.g., user television equipment 202, user computer equipment 204, wireless user communications device 206) may be referred to as a “secondary device”. For example, a secondary device may supplement content presented on a first user equipment device or display content as requested by the first user equipment device or vice versa, the first user equipment device being a mobile device. In some embodiments, the first user device provides an interface for adjusting settings and display preferences of the secondary device. In this way, users may connect a mobile device (a first user device) to a larger secondary device, for example, and use the mobile device as a control device for the larger secondary device, e.g., to control the volume level output from the secondary device. For example, the smaller mobile device may be used as a touch-pad for controlling settings of the secondary device or for interacting with the secondary device. The user may initiate volume control using methods disclosed herein and, in some embodiments, may adjust the volume level that is output from the secondary device using any of the user actions discussed above on the user's mobile device. For example, a dragging motion for volume adjustment can be implemented on the display screen on the mobile device to increase, decrease, or mute the volume on the secondary device.

FIG. 7 shows an example diagram illustrating the concept of proximity depth of a proximity sensor. A proximity sensor (not shown) can be provided at an internal area of the mobile terminal 702 enclosed by the touchscreen or around the touchscreen. The proximity sensor is a sensor that detects a presence or non-presence of an object approaching a specific detecting surface or an object existing around the proximity sensor using an electromagnetic field strength or infrared ray without mechanical contact. Therefore, the proximity sensor may be more durable than a contact-type sensor and also provides wider utility than a contact-type sensor.

The proximity sensor may include, however it is not limited to, a direct reflective photoelectric sensor, a mirror reflective photoelectric sensor, a radio frequency oscillation proximity sensor, an electrostatic capacity proximity sensor, a magnetic proximity sensor, an infrared proximity sensor or similar sensors. If the touchscreen includes an electrostatic capacity proximity sensor, it is configured to detect the proximity of a pointer using a variation of electric field according to the proximity of the pointer. In this case, the touchscreen (touch sensor) can be classified as the proximity sensor.

In the following description, an action where a pointer 704, e.g., a user's finger or a proximity pen, that approaches, without contacting, the touchscreen and is recognized as located on the touchscreen is called a “proximity touch”, e.g., when the pointer 704 is between positions d0 and d3 as shown in FIG. 7. It shall be appreciated that the proximity touch at different proximity levels, d1, d2, d3, between d1 and d2 and/or between d2 and d3, can be used to initiate different functions on the mobile terminal 702. An action where a pointer 704 touches the touchscreen, e.g., at position d0 as shown in FIG. 7, may be called a “contact touch”. The meaning of a position on the touchscreen proximity-touched by the pointer 704 is a position of the pointer or gesture that is opposite the display of the mobile device when the pointer performs the proximity touch. As illustrated in FIG. 7, when a pointer approaches the touchscreen, the proximity sensor provided within or in the vicinity of the touchscreen detects the approach or the gesture of the pointer and then outputs a signal in accordance with the gesture.

The proximity sensor detects a proximity touch and a proximity-touch pattern (e.g., a proximity-touch distance, duration, position, or any other gesture for example). Information corresponding to the detected proximity touch and the proximity detected pattern can be output to the display of the mobile device. In this way, a gesture (using a proximity touch), e.g., picked up by a camera, or touchscreen recognition (using a contact touch), can be used to control volume levels. For example, user actions may include, however are not limited to, flicking a pointer or a pen, clicking a button on the proximity pen or any other action stored on the mobile device used to detect or to determine that the user wishes to initiate volume control and/or adjust the volume of the content being consumed. The user may initiate volume control using a gesture and then, following volume control initiation, adjust the volume level of the audio of the mobile device using the dragging motion as discussed above.

Augmented Reality (AR) is an interactive experience of a real-world environment where the objects that reside in the real world are enhanced by computer-generated perceptual information, sometimes across multiple sensory modalities, including visual, auditory, and haptic, to name a few. Virtual Reality (VR), on the other hand, is a simulated experience that can be similar to or completely different from the real world. Extended Reality (XR) is an umbrella term encapsulating Augmented Reality, Virtual Reality, Mixed Reality (MR), and everything in between. These applications can offer a wide range of revolutionary experiences to the user, and the same underlying systems and methods of volume adjustment described herein may be implemented in AR, VR, as well as XR systems and applications. For example, volume adjustment may be done using a controller in a similar implementation to a proximity touch as described above.

In will be appreciated that the media guidance application may perform one or more of the functions described above simultaneously.

As referred herein, the term, “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods. Additionally any of the steps in said processes can be performed in any order, can be omitted, and/or can be combined with any of the steps from any other process.

While some portions of this disclosure may make reference to “convention,” any such reference is merely for the purpose of providing context to the invention(s) of the instant disclosure, and does not form any admission as to what constitutes the state of the art.

1. A method of adjusting a volume level on a mobile device for a media asset, the method comprising:
receiving the media asset comprising an audio component;
outputting the audio component of the media asset at a first volume level on the mobile device;
initiating volume control and, in response to initiating volume control, generating a 2D grid on a display of the mobile device for adjusting the volume level from the first volume level to a second volume level;
detecting a user action for adjusting the volume level, wherein the user action comprises determining a first location on the 2D grid corresponding to the first volume level;
determining the second volume level by determining that the user action has ended at a second location on the 2D grid corresponding to the second volume level; and
outputting the audio component of the media asset at the second volume level.

2. The method of claim 1, wherein the step of initiating volume control comprises any one of: selecting a volume icon; selecting a volume bar; pressing a volume button on the mobile device; detecting user input at a predetermined location; and/or detecting a gesture at a close proximity to the display.

3. The method of claim 1, wherein the user action comprises a dragging action on the 2D grid from the first location to the second location.

4. The method of claim 1, wherein the second volume level is determined based on a displacement of the second location with respect to the first location on the 2D grid.

5. The method of claim 1, wherein the second volume level is determined based on any one or more of: a user preference; a user profile; type of content; and/or historical volume level adjustments.

6. The method of claim 1, wherein a plurality of predetermined locations are pre-set on the 2D grid for the second location, each of the plurality of predetermined locations corresponding to a plurality of predetermined volume levels.

7. The method of claim 6, wherein the second volume level is determined to be one of the plurality of predetermined volume levels.

8. The method of claim 1, wherein determining that the user action has ended comprises any one of: determining that the user action has stopped; determining that the user action has stabilized for a threshold period of time; determining that the distance between the first location and the second location has stabilized for a threshold period of time; and/or determining a second user action for outputting the second volume level.

9. A system for of adjusting a volume level on a mobile device for a media asset, the system comprising:
a memory storing instructions; and
control circuitry configured to execute the instructions to:
receive the media asset comprising an audio component;
output the audio component of the media asset at a first volume level on the mobile device;
initiate volume control and, in response to initiating volume control, means for generating a 2D grid on a display of the mobile device for adjusting the volume level from the first volume level to a second volume level;
detect a user action for adjusting the volume level, wherein the user action comprises determining a first location on the 2D grid corresponding to the first volume level;
determine the second volume level by determining that the user action has ended at a second location on the 2D grid corresponding to the second volume level; and
output the audio component of the media asset at the second volume level.

10. The system of claim 9, wherein the control circuitry is further configured to execute the instructions to initiate volume control by receiving at least one of: selection of a volume icon; selection of a volume bar; a pressing of a volume button on the mobile device; a user input detected at a predetermined location; or a gesture detected at a close proximity to the display.

11. The system of claim 9, wherein the user action comprises a dragging action on the 2D grid from the first location to the second location.

12. The system of claim 9, wherein the control circuitry is further configured to execute the instructions to determine the second volume level by determining a displacement of the second location with respect to the first location on the 2D grid.

13. The system of claim 9, wherein the second volume level is determined based on any one or more of: a user preference; a user profile; type of content; and/or historical volume level adjustments.

14. The system of claim 9, wherein a plurality of predetermined locations are pre-set on the 2D grid for the second location, each of the plurality of predetermined locations corresponding to a plurality of predetermined volume levels.

15. The system of claim 14, wherein the second volume level is determined to be one of the plurality of predetermined volume levels.

16. The system of claim 9, wherein the control circuitry is further configured to execute the instructions to determine the second volume level by determining that the user action has ended by: determining that the user action has stopped; determining that the user action has stabilized for a threshold period of time; determining that the distance between the first location and the second location has stabilized for a threshold period of time; or determining a second user action for outputting the second volume level.

17. A non-transitory computer-readable medium comprising non-transitory computer-readable instructions encoded thereon of adjusting a volume level on a mobile device for a media asset, the instructions comprising:
instructions for receiving the media asset comprising an audio component;
instructions for outputting the audio component of the media asset at a first volume level on the mobile device;
instructions for initiating volume control and, in response to initiating volume control, instructions for generating a 2D grid on a display of the mobile device for adjusting the volume level from the first volume level to a second volume level;
instructions for detecting a user action for adjusting the volume level, wherein the user action comprises determining a first location on the 2D grid corresponding to the first volume level;
instructions for determining the second volume level by determining that the user action has ended at a second location on the 2D grid corresponding to the second volume level; and
instructions for outputting the audio component of the media asset at the second volume level.

18. The non-transitory computer-readable medium of claim 17, wherein the instructions for initiating volume control comprises any one of: selecting a volume icon; selecting a volume bar; pressing a volume button on the mobile device; detecting user input at a predetermined location; and/or detecting a gesture at a close proximity to the display.

19. The non-transitory computer-readable medium of claim 17, wherein the user action comprises a dragging action on the 2D grid from the first location to the second location.

20. The non-transitory computer-readable medium of claim 19, wherein instructions for determining the second volume level comprises instructions for determining a displacement of the second location with respect to the first location on the 2D grid.

21-24. (canceled)
